(19) United States
(12) Patent Application Publication
(10) Pub. No.: US 2015/0309463 A1
(43) Pub. Date: Oct. 29, 2015

(54) SHEET POST-PROCESSING DEVICE

(71) Applicant: GRADCO JAPAN LTD., Tokyo (JP)

(72) Inventors: Kazushige MASUNARI, Tokyo (JP); Yumiko KATO, Tokyo (JP); Hiroshi TSUCHIYA, Tokyo (JP)

(21) Appl. No.: 14/650,759

(22) PCT Filed: Nov. 18, 2013
(86) PCT No.: PCT/JP2013/081070

§ 371 Date: Jun. 9, 2015

(30) Foreign Application Priority Data
Dec. 10, 2012 (JP) 2012-269221
Oct. 15, 2013 (JP) 2013-214657

(51) Int. Cl. G03G 15/00; B42B 5/06; B65H 37/04; B65H 33/08; B65H 39/10

(52) U.S. Cl. CPC G03G 15/6544; B65H 33/08; B65H 39/10; B65H 37/04; B42B 5/06

(57) ABSTRACT

The paper particle dust generated in the staple-processing for biding image-formed sheets without using any staple would not smear images on sheets or would not spread inside of the device. Provided are a staple unit 410 configured to automatically form a cut-in tongue portion and a cut-in hole in a predetermined shape through a sheet bundle including a plurality of sheets, insert the cut-in tongue portion into the cut-in hole to join the sheets of the sheet bundle with each other, and staple the sheet bundle, a sheet bundle discharge means 70 configured to discharge the stapled sheet bundle 110, and a stacking tray 3 configured to stack the stapled sheet bundle 110 discharged, wherein a discharge position of the stapled sheet bundle 110 discharged by the sheet bundle discharge means 70 and a stacking position of the stapled sheet bundle 110 with the stacking tray 3 are set so that the stapled sheet bundle 110 is dropped on the stacking tray 3 and stacked so that the stapled sheet bundle 110 is overlaid in such a manner that the position of the stapled sheet bundle 110 is not displaced.

### TECHNICAL FIELD

This invention relates to a sheet post-processing device conventionally connected to an image forming apparatus such as a copier and a printer and performing staple-processing for biding image-formed sheets without using any staple.

### BACKGROUND ART

An image forming apparatus such as a copier and a printer is implemented with more and more functions, and includes a storage device for storing many images, and the image forming apparatus forming images for each set has become the mainstream, and as the functions of the image forming apparatus increase, there has emerged an image forming apparatus including a sheet post-processing device for performing post-processing such as staple-processing and the like onto sheets that have been recorded and output (see Patent Literature 1 to Patent Literature 4).

When such a conventional sheet post-processing device performs staple-processing in general, the sheet post-processing device drives a metallic staple (staple) into multiple sheets which are to be bound, thereby biding the multiple sheets with the metallic staple itself.

However, when a metallic staple is used to perform staple-processing, staples are consumables, and this increases the cost of consumables, and in addition, when stapled sheets are shredded, it is necessary to remove the staples, which degrades the workability, and moreover, there is a problem in that, when stapled sheets are shredded without removing staples, this may cause malfunction in the shredder, and the recycling efficiency is low.

Accordingly, document binding devices have been suggested to bind documents without using any staple (see Patent Literature 5 to Patent Literature 8).

### CITATION LIST

### Patent Literature

### Patent Literature 1: JP 06-72060 A

### Patent Literature 2: JP 2001-130826 A

### Patent Literature 3: JP 2002-96963 A

### Patent Literature 4: JP 2001-316034 A

### Patent Literature 5: JP 49-5960 B

### Patent Literature 6: JP 2005-74787 A

### Patent Literature 7: JP 2005-74858 A

### Patent Literature 8: JP 2012-148505 A

### SUMMARY OF INVENTION

### Technical Problem

A document binding device for biding documents without using any staple forms a joint portion such as a cut portion or a recessed portion in a predetermined shape on a sheet bundle including multiple sheets, and binds the sheet bundle by joining the sheets of the sheet bundle with each other at the joint portion, and therefore, at the joint portion, a difference in the level occurs due to binding. Therefore, when stapled sheet bundles are stacked in an overlapping manner on the stacking tray, the stapled sheet bundles may be displaced due to a difference in the level.

This invention is made in view of such circumstances, and it is an object of this invention to provide a sheet post-processing device capable of stacking stapled sheet bundles in an overlapping manner without any deviation in the positions on the stacking tray.

### Solution to Problem

In order to solve the above problems and achieve the above objects, this invention is configured as follows.

The invention according to claim 1 is a sheet post-processing device connected to an image forming apparatus, the sheet post-processing device being successively fed with sheets on which images are formed by the image forming apparatus on the basis of input image data, the sheet post-processing device applying predetermined post-processing onto the fed sheet,

the sheet post-processing device comprising:

a staple unit configured to automatically form a cut-in tongue portion and a cut-in hole in a predetermined shape through a sheet bundle including a plurality of sheets, insert the cut-in tongue portion into the cut-in hole to join the sheets of the sheet bundle with each other, and staple the sheet bundle;

a sheet bundle discharge means configured to discharge the stapled sheet bundle; and

a stacking tray configured to stack the stapled sheet bundle discharged,

wherein a discharge position of the stapled sheet bundle discharged by the sheet bundle discharge means and a stacking position of the stapled sheet bundle with the stacking tray are set so that the stapled sheet bundle is dropped stacked so that the stapled sheet bundle is overlaid in such a manner that the position of the stapled sheet bundle on the stacking tray is not displaced.

The invention according to claim 2 is the sheet post-processing device according to claim 1, wherein the sheet bundle discharge means includes:

a support, wherein when the support is at a forward position, the support drops a leading end side of the stapled sheet bundle onto the stacking tray, so that only a trailing end portion of the sheet bundle is placed on the support, and when the support is moved backward, the support drops the trailing end portion of the sheet bundle onto the stacking tray to stack the sheet bundle; and

support driving means configured to move the support forward and backward,

wherein the support driving means drives the support, and sets the discharge position of the stapled sheet bundle from the support and the stacking position of the stapled sheet bundle with the stacking tray, and is configured to drop the stapled sheet bundle on the stacking tray and stack the stapled sheet bundle in an overlapping manner without any positional deviation, and

the setting of the discharge position of the stapled sheet bundle from the support and the stacking position of the stapled sheet bundle with the stacking tray is such that, when the support is moved backward, a position where the stapled sheet bundle drops on the stacking tray is a position of coming into contact with a reception wall of the stacking tray, and the stapled sheet bundle is stacked so that the stapled sheet bundle is overlaid in such a manner that the position of the stapled sheet bundle is not displaced.

The invention according to claim 3 is the sheet post-processing device according to claim 1, wherein the sheet bundle discharge means includes:

a discharge roller configured to discharge the stapled sheet bundle onto the stacking tray; and

roller driving means configured to drive the discharge roller,

wherein the roller driving means drives the discharge roller, and sets the discharge position of the stapled sheet bundle from the discharge roller and the stacking position of the stapled sheet bundle with the stacking tray, and is configured to drop the stapled sheet bundle on the stacking tray and stack the stapled sheet bundle in an overlapping manner without any positional deviation, and

the setting of the discharge position of the stapled sheet bundle from the discharge roller and the stacking position of the stapled sheet bundle with the stacking tray is such that a position where the stapled sheet bundle drops is a position of coming into contact with a reception wall of the stacking tray, and the stapled sheet bundle is stacked so that the stapled sheet bundle is overlaid in such a manner that the position of the stapled sheet bundle is not displaced.

The invention according to claim 4 is the sheet post-processing device according to claim 1, wherein the sheet bundle discharge means includes:

a discharge clip configured to discharge the stapled sheet bundle onto the stacking tray; and

clip driving means configured to drive the discharge clip,

wherein the clip driving means drives the discharge clip, and sets the discharge position of the stapled sheet bundle from the discharge clip and the stacking position of the stapled sheet bundle with the stacking tray, and is configured to drop the stapled sheet bundle on the stacking tray and stack the stapled sheet bundle in an overlapping manner without any positional deviation, and

the setting of the discharge position of the stapled sheet bundle from the discharge clip and the stacking position of the stapled sheet bundle with the stacking tray is such that a position where the stapled sheet bundle drops is a position of coming into contact with a reception wall of the stacking tray, and the stapled sheet bundle is stacked so that the stapled sheet bundle is overlaid in such a manner that the position of the stapled sheet bundle is not displaced.

The invention according to claim 5 is the sheet post-processing device according to any one of claims 1 to 4 further comprising a paper particle dust accommodation unit configured to accommodate paper particle dust generated when the cut-in tongue portion and the cut-in hole in the predetermined shape are formed.

The invention according to claim 6 is the sheet post-processing device according to claim 5 further comprising warning means configured to notify removal of the paper particle dust accumulated in the paper particle dust accommodation unit.

The invention according to claim 7 is the sheet post-processing device according to claim 6, wherein the warning means is configured to detect the number of times the staple operation is performed, and notify removal of the paper particle dust accumulated in the paper particle dust accommodation unit when the number of times the staple operation is performed attains the number of operations that has been set.

The invention according to claim 8 is the sheet post-processing device according to claim 6, wherein the warning means detects the number of sheets to be stapled, and notify removal of the paper particle dust accumulated in the paper particle dust accommodation unit when the number of sheets to be stapled attains the number of sheets that has been set.

The invention according to claim 9 is the sheet post-processing device according to claim 5, wherein the paper particle dust accommodation unit includes:

a dust shoot configured to guide the paper particle dust;

a storage box configured to accumulate the paper particle dust; and

dust collector means configured to collect the paper particle dust into the storage box.

The invention according to claim 10 is the sheet post-processing device according to claim 9, wherein the storage box is provided with preventing means configured to prevent the paper particle dust from attaching to an inner wall of the storage box.

The invention according to claim 11 is the sheet post-processing device according to claim 9, wherein the storage box is detachable.

### Advantageous Effects of Invention

According to the above configuration, this invention has the following effects.

The invention according to claim 1 includes sheet bundle discharge means configured to discharge the stapled sheet bundle and the stacking tray configured to stack the stapled sheet bundle discharged, and the discharge position of the stapled sheet bundle discharged by the sheet bundle discharge means and the stacking position of the stapled sheet bundle with the stacking tray are set so that the stapled sheet bundle is dropped on the stacking tray and stacked so that the stapled sheet bundle is overlaid in such a manner that the position of the stapled sheet bundle is not displaced, and therefore, the stapled sheet bundle can be stacked so that the stapled sheet bundle can be overlaid in such a manner that the position of the stapled sheet bundle on the stacking tray is not displaced when the staples get stuck.

In the invention according to claim 2, the setting of the discharge position of the stapled sheet bundle from the support and the stacking position of the stapled sheet bundle with the stacking tray is such that, when the support is moved backward, the position where the stapled sheet bundle drops on the stacking tray is the position of coming into contact with the reception wall of the stacking tray, and the stapled sheet bundle can be stacked so that the stapled sheet bundle can be overlaid in such a manner that the position of the stapled sheet bundle on the stacking tray is not displaced when the staples get stuck.

In the invention according to claim 3, the setting of the discharge position of the stapled sheet bundle from the discharge roller and the stacking position of the stapled sheet bundle with the stacking tray is such that the position where the stapled sheet bundle drops is the position of coming into contact with a reception wall of the stacking tray, and the stapled sheet bundle can be stacked so that the stapled sheet bundle can be overlaid in such a manner that the position of the stapled sheet bundle on the stacking tray is not displaced when the staples get stuck.

In the invention according to claim 4, the setting of the discharge position of the stapled sheet bundle from the discharge clip and the stacking position of the stapled sheet bundle with the stacking tray is such that the position where the stapled sheet bundle drops is the position of coming into contact with a reception wall of the stacking tray, and the stapled sheet bundle can be stacked so that the stapled sheet bundle can be overlaid in such a manner that the position of the stapled sheet bundle on the stacking tray is not displaced when the staples get stuck.

In the invention according to claim 5, the cut-in tongue portion and the cut-in hole in the predetermined shape are formed automatically through the sheet bundle including the plurality of sheets, and the cut-in tongue portion is inserted into the cut-in hole to join the sheets of the sheet bundle with each other, so that the sheet bundle is stapled, and paper particle dust generated when the cut-in tongue portion and the cut-in hole in the predetermined shape are formed is accommodated, so that there is no need to provide a sensor for checking the state of filling of the staples, and this makes the structure simpler, and the paper particle dust generated in the staple-processing would not smear images on sheets or would not spread inside of the device.

In the invention according to claim 6, removal of the paper particle dust accumulated in the paper particle dust accommodation unit is notified, so that the paper particle dust accumulated in the paper particle dust accommodation unit can be reliably removed.

In the invention according to claim 7, the number of times the staple operation is performed is detected, and when the number of times the staple operation is performed attains the number of operations that has been set, removal of the paper particle dust accumulated in the paper particle dust accommodation unit is notified, so that the paper particle dust accumulated in the paper particle dust accommodation unit can be reliably removed.

In the invention according to claim 8, the number of sheets to be stapled is detected, and when the number of sheets to be stapled attains the number of sheets that has been set, removal of the paper particle dust accumulated in the paper particle dust accommodation unit is notified, so that the paper particle dust accumulated in the paper particle dust accommodation unit can be reliably removed.

In the invention according to claim 9, the paper particle dust can be reliably accumulated in the storage box.

In the invention according to claim 10, the paper particle dust is prevented from attaching to an inner wall of the storage box, so that the paper particle dust can be easily retrieved from the storage box.

In the invention according to claim 11, the storage box is detachable, and the paper particle dust can be easily retrieved.

### BRIEF DESCRIPTION OF DRAWINGS

FIG. 1 is a top view illustrating a sheet post-processing device.

FIG. 2 is a front view illustrating the sheet post-processing device.

FIG. 3 is a side view illustrating the sheet post-processing device.

FIG. 4 is a perspective view illustrating the sheet post-processing device.

FIG. 5 is a configuration diagram illustrating the sheet post-processing device.

FIGS. 6 a) to 6 c) are cross sectional views illustrating the sheet post-processing device.

FIGS. 7(a) and 7(b) are figures illustrating operation of support.

FIG. 8 is a figure illustrating a stack and a jogger.

FIGS. 9(a) and 9(b) are figures illustrating stacking of a sheet bundle.

FIGS. 10(a) to 10(c) are figures illustrating a state of a jogger and a stack.

FIGS. 11(a) to 11(c) are figures illustrating a state of staple.

FIG. 12 is a figure for explaining operation in a case where sheets are not stapled.

FIG. 13 is a figure for explaining operation in a case where sheets are not stapled.

FIG. 14 is a figure for explaining operation in a case where sheets are stapled.

FIG. 15 is a figure for explaining operation in a case where sheets are stapled.

FIGS. 16(a) and 16(b) are perspective views illustrating an external appearance of a staple device.

FIGS. 17(a) to 17(c) are cross sectional views illustrating a staple device.

FIG. 18 is a figure illustrating operation for closing a sheet bundle.

FIG. 19 is a figure illustrating operation for closing a sheet bundle.

FIG. 20 is a figure illustrating operation for closing a sheet bundle.

FIG. 21 is a figure illustrating operation for closing a sheet bundle.

FIG. 22 is a figure illustrating operation for closing a sheet bundle.

FIG. 23 is a perspective view illustrating a sheet bundle before being stapled.

FIG. 24 is a perspective view illustrating a sheet bundle in a state of being stapled.

FIG. 25 is a figure illustrating a stapled sheet bundle.

FIGS. 26(a) and 26(b) are configuration diagrams illustrating warning means.

### DESCRIPTION OF EMBODIMENTS

Hereinafter, an embodiment of a sheet post-processing device according to this invention will be explained. The embodiment of this invention shows the most preferred mode of the invention, but this invention is not limited thereto.

### (Configuration of Sheet Post-Processing Device)

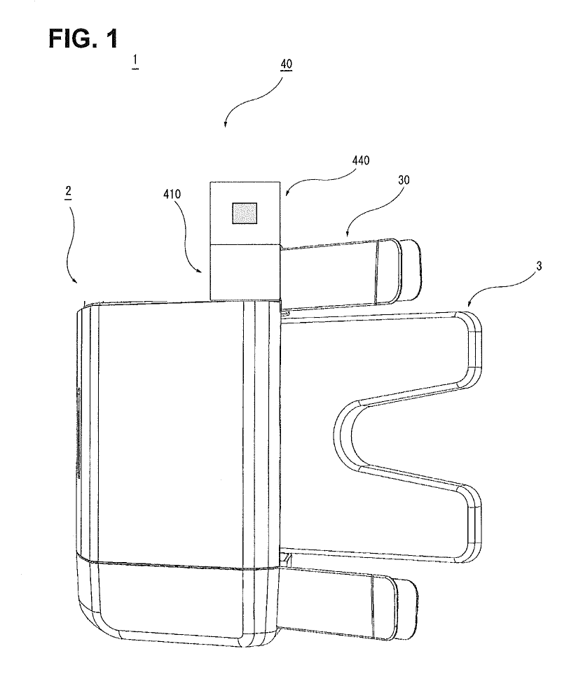

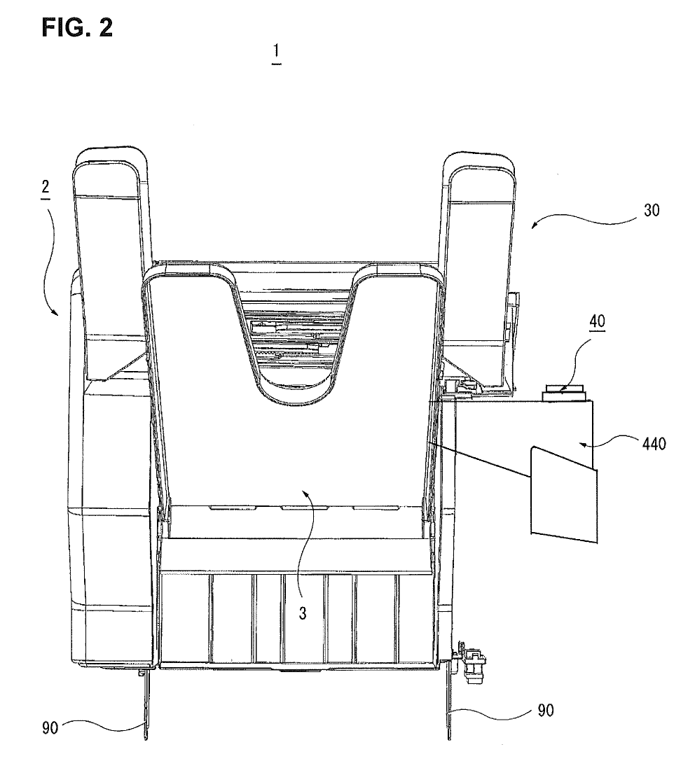

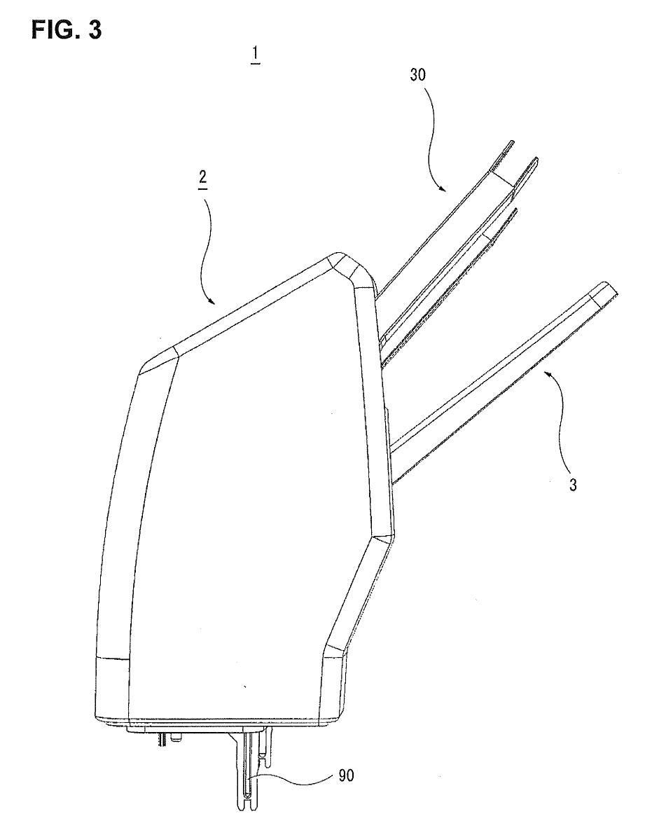

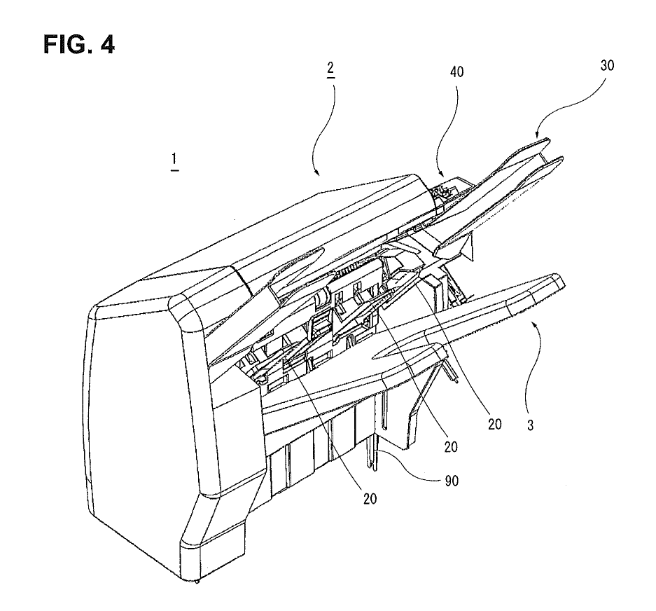

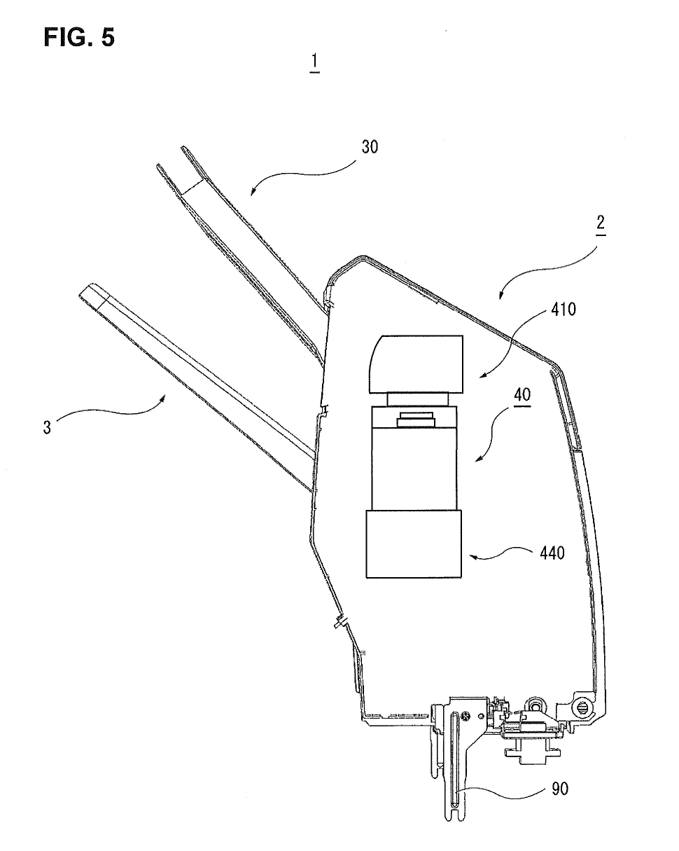

FIG. 1 is a top view illustrating a sheet post-processing device. FIG. 2 is a front view illustrating a sheet post-processing device. FIG. 3 is a side view illustrating a sheet post-processing device. FIG. 4 is a perspective view illustrating a sheet post-processing device. FIG. 5 is a configuration diagram illustrating a sheet post-processing device.

A sheet post-processing device 1 according to an embodiment includes a stacking tray 3, a support 20, jogger and stack means 30, a staple device 40, and sheet conveying means 10 provided in a device main body 2. At the bottom portion of the device main body 2, positioning members 90 are provided in a protruding manner to the lower side at both of the right and left sides, and the sheet post-processing device 1 is arranged by inserting the positioning members 90 into the upper portion of an image forming apparatus such as a copier and a printer, so that sheets discharged from the image forming apparatus are conveyed into the sheet post-processing device 1 from the lower side. The sheet conveying means 10 is configured to convey sheets fed from the upper portion of the image forming apparatus to the stacking tray 3, and the jogger and stack means 30 and the staple device 40 perform jogger and stack processing and staple-processing, and the processed sheet bundles are stacked on the stacking tray 3.

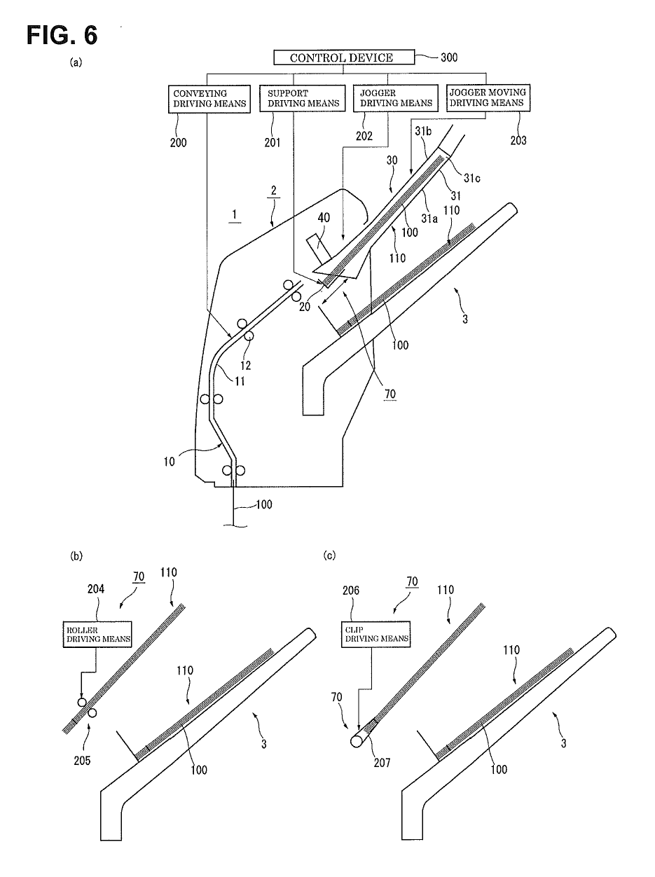

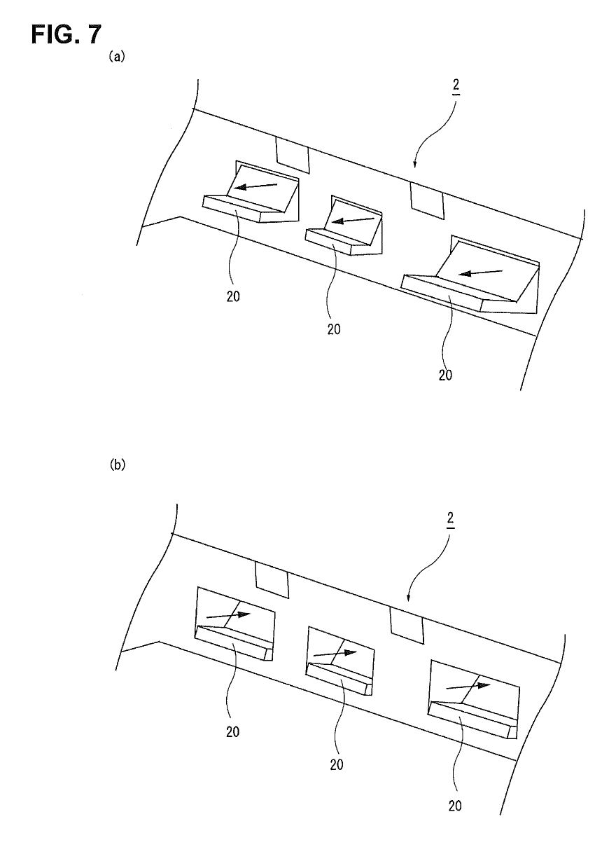

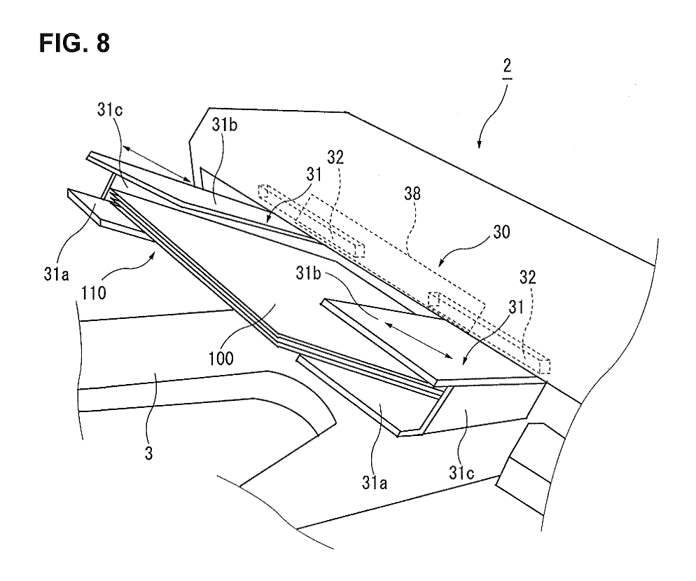

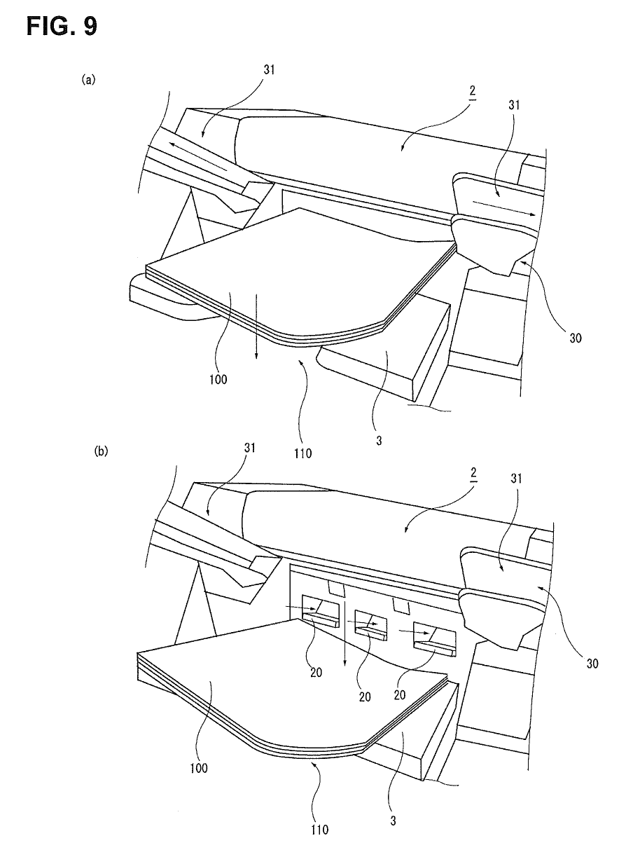

FIGS. 6(a) to 6(c) to FIGS. 9(a) and 9(b) illustrate operation of a sheet post-processing device. FIGS. 6(a) to 6(c) are control diagrams illustrating a sheet post-processing device. FIGS. 7(a) and 7(b) illustrate operation of a support. FIG. 7(a) is a figure illustrating a state in which the support moves backward. FIG. 7(b) is a figure illustrating a state in which the support moves forward. FIG. 8 is a perspective view illustrating a stack and a jogger. FIGS. 9(a) and 9(b) illustrate stacking of a sheet bundle. FIG. 9(a) is a figure illustrating a state in which a leading end side of an aligned sheet bundle is dropped on the stacking tray. FIG. 9(b) is a figure illustrating a state in which a trailing end side of an aligned sheet bundle is dropped on the stacking tray.

The device main body 2 according to this embodiment is arranged with sheet conveying means 10, a support 20, jogger and stack means 30, a staple device 40, and the like. The sheet conveying means 10 includes a conveying guide 11 and a conveying roller 12, and conveys sheets 100, conveyed from the image forming apparatus, from a lower side position of the device main body 2 onto the stacking tray 3. The conveying roller 12 is driven by conveying driving means 200 constituted by power transmission means and the like including, e.g., a motor, a belt, a gear, and the like, and this conveying driving means 200 drives the conveying roller 12 to convey the sheets 100.

For example, three supports 20 are arranged side by side in the horizontal direction at the upper side position of the stacking tray 3. This support 20 can move forward and backward in the sheet discharge direction on the device main body 2, and supports the trailing end portion of the sheets 100 discharged by the sheet conveying means 10 when the support 20 is at the forward position, and drops the trailing end portion of the sheets 100 discharged by the sheet conveying means 10 when the support 20 is at the backward position. The support 20 is driven by the support driving 201 constituted by power transmission means and the like made of, e.g., a motor, a cam, and the like, and this support driving 201 moves the support 20 forward and backward.

The jogger and stack means 30 includes a pair of right and left joggers 31 for stacking and jogging. The pair of right and left joggers 31 can move in the right and left directions with respect to the sheet discharge center position on the device main body 2. The pair of right and left joggers 31 has a C-shaped cross section made up with a lower guide 31a, a upper guide 31b, and a connection guide 31c, and stacks and jogs the sheets by supporting the leading end both-sides end portion and the leading end both-sides bottom portion of the sheets discharged by the sheet conveying means 10.

The pair of right and left joggers 31 is provided on a moving body 38 with slide levers 32. Aligning, opening, and closing of the pair of right and left joggers 31 are driven by jogger driving means 202 constituted by power transmission means and the like made of, e.g., a motor, an operation shaft, and the like. Moving of the pair of right and left joggers 31 in the right and left direction is driven by jogger moving driving means 203 constituted by power transmission means and the like made of, e.g., motor, gear, belt, and the like. The pair of right and left joggers 31 aligns the sheets 100.

The jogger and stack means 30 is arranged at the upper side position with respect to the stacking tray 3, and the supports 20 are configured to be arranged between the stacking tray 3 and the jogger and stack means 30. For this reason, the sheets 100 discharged by the sheet conveying means 10 are such that the leading end side thereof is supported by the pair of right and left joggers 31 of the jogger and stack means 30, and the trailing end portion is placed on the supports 20 at the forward position to be aligned, so that the sheets are made into a sheet bundle 110. At this occasion, the support 20 supports the width direction inner side of the trailing end portion of the sheet 100, and supports the width direction inner side of the trailing end portion of the sheet bundle 110 aligned by the support 20, and therefore, even if a sheet 100 is curled around the conveying direction due to the structure of the conveying system of the image forming apparatus, this can alleviate deviation of the sheet bundle 110.

By opening the pair of right and left joggers 31, the leading end side of the aligned sheet bundle 110 is dropped on the stacking tray 3, and only the trailing end portion of the sheet bundle 110 is placed on the supports 20, and then the supports 20 are moved backward, so that the trailing end portion of the sheet bundle 110 placed on the supports 20 is dropped on the stacking tray 3 to be stacked.

When the sheet bundle 110 is stacked at this occasion, the pair of right and left joggers 31 has the C-shaped cross section made up with the lower guide 31a, the upper guide 31b, and the connection guide 31c, and is supporting the leading end both sides end portion and the leading end both sides bottom portion of the sheet 100, and therefore, by opening the pair of right and left joggers 31, the leading end side of the aligned sheet bundle 110 is dropped on the stacking tray 3. The trailing end portion of the sheet bundle 110 is placed on the support 20, and this support 20 is arranged between the stacking tray 3 and the jogger and stack means 30, and is at a position lower than the pair of right and left joggers 31, and when the support 20 is moved backward, and the trailing end portion of the sheet bundle 110 placed on the supports 20 is dropped on the stacking tray 3 to be stacked, the sheet bundle 110 can be smoothly and quickly dropped on the stacking tray 3, and in addition, when the sheet bundle 110 is dropped, air escapes from the leading end side to the trailing end side of the sheet bundle 110, and therefore, the stacked sheet bundle 110 is not displaced due to the air.

The pair of right and left joggers 31 is arranged above the stacking tray 3, and the supports 20 are arranged between the stacking tray 3 and the pair of right and left joggers 31, and the support 20 is at a position lower than the pair of right and left joggers 31, so that by moving the supports 20 backward, the sheet bundle 110 can be dropped on the stacking tray 3 to be stacked thereon in a short time, and a subsequent sheet 100 can be received with the pair of right and left joggers 31, whereby the reception time can be reduced, and the productivity can be improved.

The staple device 40 is incorporated and arranged at the right side of the device main body 2, and the sheet bundle 110 aligned by the jogger and stack means 30 is stapled by the staple device 40, and this staple is configured to staple the corner portion of the rear end of the aligned sheet bundle 110 without using any staple.

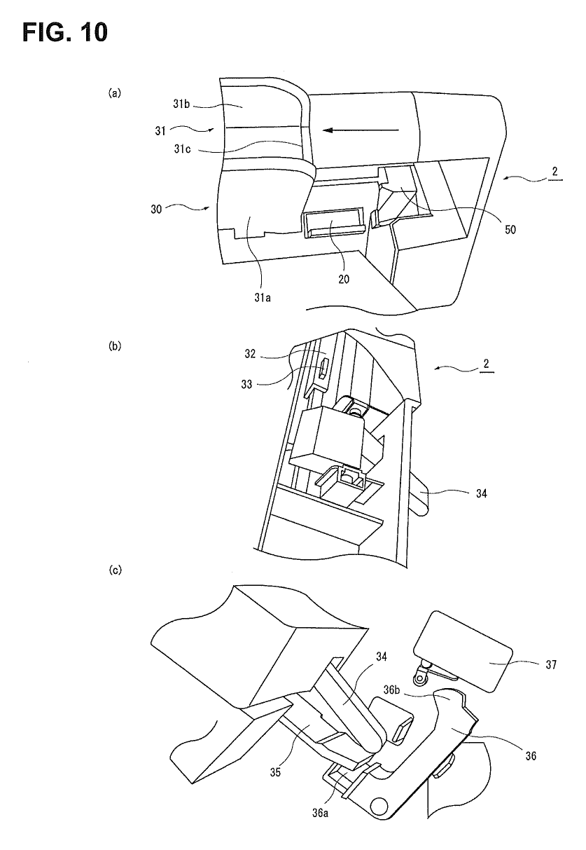

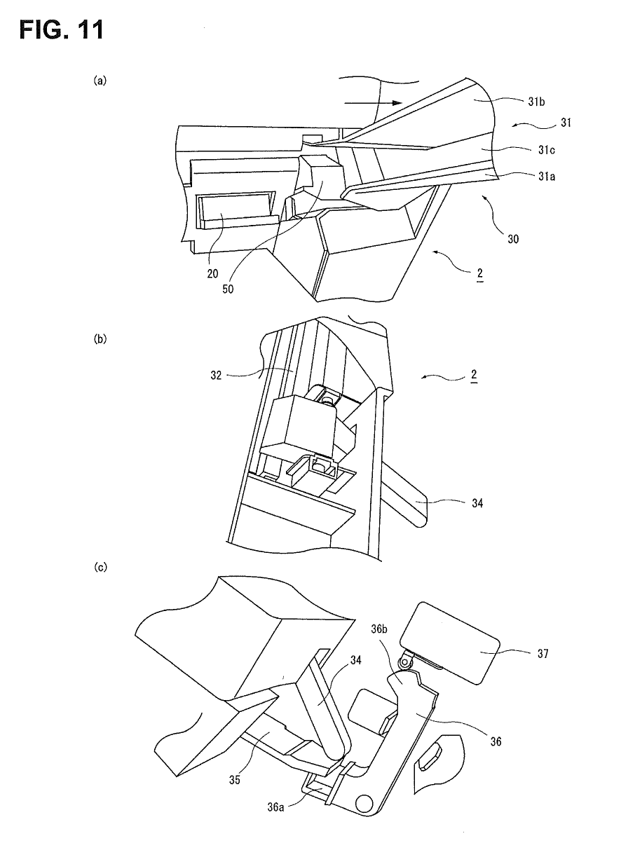

FIGS. 10(a) to 10(c) are figures illustrating a state of the jogger and the stack. FIGS. 11(a) to 11(c) are figures illustrating a state of a staple. At the right side of the device main body 2, a sheet bundle holder 50 is arranged at a position where the sheet bundle 110 aligned by the jogger and stack means 30 is stapled. This sheet bundle holder 50 presses the sheet bundle 110 to be stapled.

In FIGS. 10(a) to 10(c), the pair of right and left joggers 31 of the jogger and stack means 30 is at the position of the jogger and the stack, and the sheet bundle holder 50 functions as a cover for covering the staple device 40 to prevent a finger and the like from entering the position where stapling is performed. In this state, a protrusion 33 formed on a slide lever 32 supporting the right-side jogger 31 is at the position where the arm 34 is not operated. When the arm 34 presses an end portion 36a which is one of end portions of a link 36 via an auxiliary lever 35, the end portion 36b which is the other of end portions of the link 36 presses a contact point 37a of a safety switch 37, so that the safety switch 37 is turned off.

When the pair of right and left joggers 31 of the jogger and stack means 30 is at the position of the jogger and the stack, the protrusion 33 formed on the slide lever 32 supporting the right-side jogger 31 is at the position where the arm 34 is not operated, and therefore, the arm 34 does not press the end portion 36a which is one of end portions of the link 36 via an auxiliary lever 35, and the link 36 does not operate, and therefore, the safety switch 37 is in the non-energized OFF state, and the operation of the staple device 40 is prohibited.

In FIG. 11, the pair of right and left joggers 31 of the jogger and stack means 30 moves to the position of the staple, and stapling is performed, but at this staple position, the protrusion 33 formed on the slide lever 32 supporting the right-side jogger 31 activates the arm 34, and therefore, the arm 34 presses the end portion 36a which is one of end portions of the link 36 via an auxiliary lever 35, and the link 36 operates, and therefore, the end portion 36b which is the other of end portions of the link 36 presses the contact point 37a of the safety switch 37, so that the safety switch 37 is in the energized ON state, and the operation of the staple device 40 operates and performs stapling.

(Operation of Sheet Post-Processing Device)

A control device 300 receives a command of the number of sheets 100 to be aligned from a control device of the image forming apparatus, and drives conveying driving means 200, a support driving 201, jogger driving means 202, and jogger moving driving means 203 to perform shift stacking operation and straight stacking operation in a case where stapling is not performed and perform shift stacking operation and straight stacking operation in a case where stapling is performed.

[Shift Stacking Operation in a Case where Stapling is not Performed]

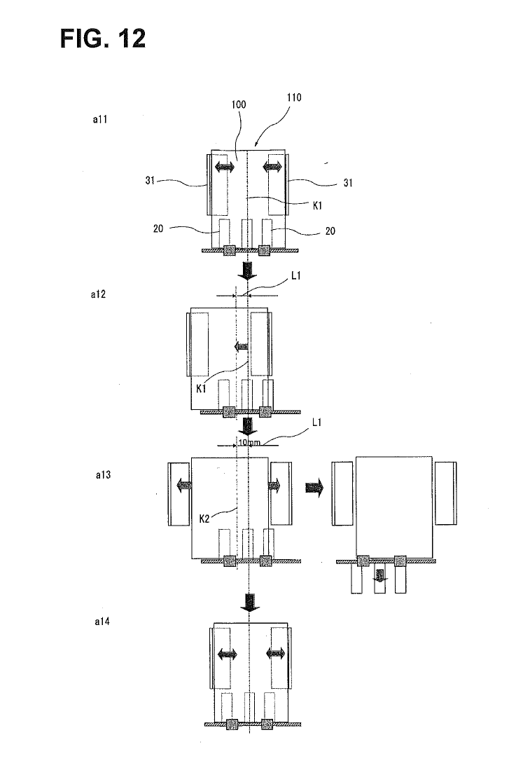

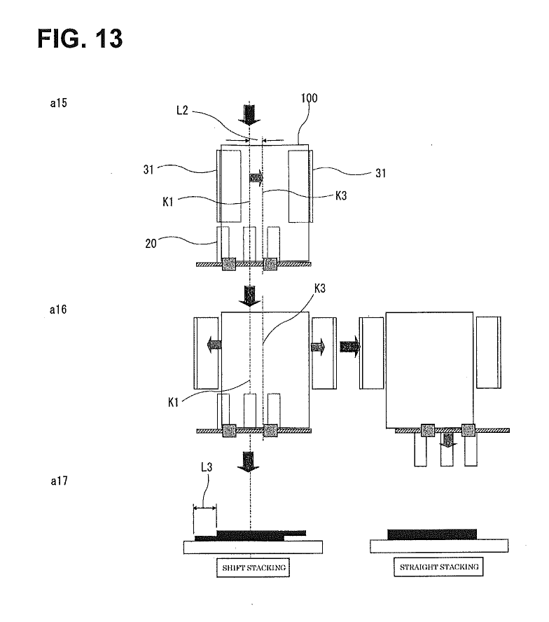

The operation in a case where stapling is not performed will be explained with reference to FIGS. 12 and 13. The pair of right and left joggers 31 can move in the right and left directions with respect to the sheet discharge center position K1, and the right-side end surface and the left-side end surface of the sheets 100 are aligned by the operation of the pair of right and left joggers 31 on the basis of the conveyed sheet discharge center position K1. The trailing end portion of the sheet 100 is supported by the supports 20 at the forward position (step a11).

After the right-side end surface and the left-side end surface of the sheet 100 are aligned, the sheets 100 are moved from the sheet discharge center position K1 in the right direction while the right-side end surface and the left-side end surface of the sheet bundle 110 are sandwiched by the pair of right and left joggers 31, so that the sheets 100 are at a stacking position K2 away by a distance L1 (step a12).

At this stacking position K2, the pair of right and left joggers 31 is opened, and the leading end side of the aligned sheet bundle 110 is dropped on the stacking tray 3, and only the trailing end portion of the sheet bundle 110 is placed on the supports 20. In this state, subsequently the supports 20 are moved backward, and the trailing end portion of the sheet bundle 110 placed on the supports 20 is dropped on the stacking tray 3 to be stacked (step a13). When this sheet bundle 110 is dropped on the stacking tray 3, air escapes from the leading end side to the trailing end side of the sheet bundle 110 to be dropped, and therefore, the stacked sheet bundle 110 is not displaced due to the air.

Subsequently, the pair of right and left joggers 31 is moved to the sheet discharge center position K1, and a sheet 100 fed subsequently is aligned so that the right-side end surface and the left-side end surface of the sheet 100 are aligned by the operation of the pair of right and left joggers 31 on the basis of the sheet discharge center position K1. The trailing end portion of the sheet 100 is supported by the supports 20 at the forward position (step a14).

After the right-side end surface and the left-side end surface of the sheet 100 are aligned, the sheets 100 are moved from the sheet discharge center position K1 in the left direction while the right-side end surface and the left-side end surface of the sheet bundle 110 are sandwiched by the pair of right and left joggers 31, so that the sheets 100 are at a stacking position K3 away by a distance L2 (step a15).

At this stacking position K3, the pair of right and left joggers 31 is opened, and the leading end side of the aligned sheet bundle 110 is dropped on the stacking tray 3, and only the trailing end portion of the sheet bundle 110 is placed on the supports 20. In this state, subsequently the supports 20 are moved backward, and the trailing end portion of the sheet bundle 110 placed on the supports 20 is dropped on the stacking tray 3 to be stacked (step a16). When this sheet bundle 110 is dropped on the stacking tray 3, air escapes from the leading end side to the trailing end side of the sheet bundle 110 to be dropped, and therefore, the stacked sheet bundle 110 is not displaced due to the air.

As described above, at the sheet discharge center position K1, the sheet bundle 110 is aligned, and moved in one of right and left directions, and the pair of right and left joggers 31 is opened at the stacking position K2, and the following operations are repeated: an operation for moving the supports 20 backward and dropping and stacking the sheet bundle 110 on the stacking tray 3; and an operation for aligning the sheet bundle 110 at the sheet discharge center position K1, moving the sheet bundle 110 in the other of the right and left directions, opening the pair of right and left joggers 31 at the stacking position K3, moving the supports 20 backward, and dropping and stacking the sheet bundle 110 on the stacking tray 3, and then the sheet bundles 110 are stacked with a deviation L3 alternately on the stacking tray 3 (step a17).

[Straight Stacking Operation in a Case where Stapling is not Performed]

Step a11 to step a13 explained in the shift stacking operation in a case where stapling is not performed are repeatedly performed, but the operation at and after step a14 is not performed. As described above, the following operation is repeated: aligning the sheet bundle 110 at the sheet discharge center position K1, moving the sheet bundle only in one of the right and left directions, opening the pair of right and left joggers 31 at the stacking position K2, and moving the supports 20 backward and dropping and stacking the sheet bundle 110 on the stacking tray 3, so that the sheet bundles 110 are stacked without any deviation alternately on the stacking tray 3.

[Shift Stacking Operation in a Case where Stapling is Performed]

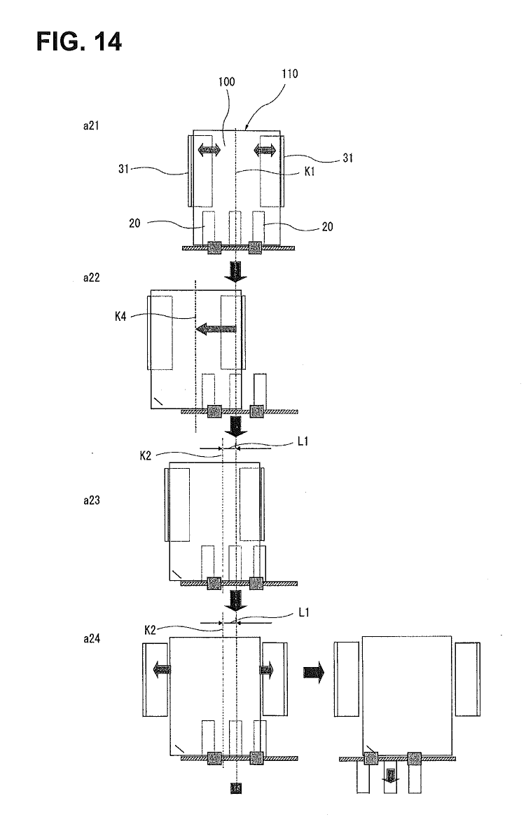

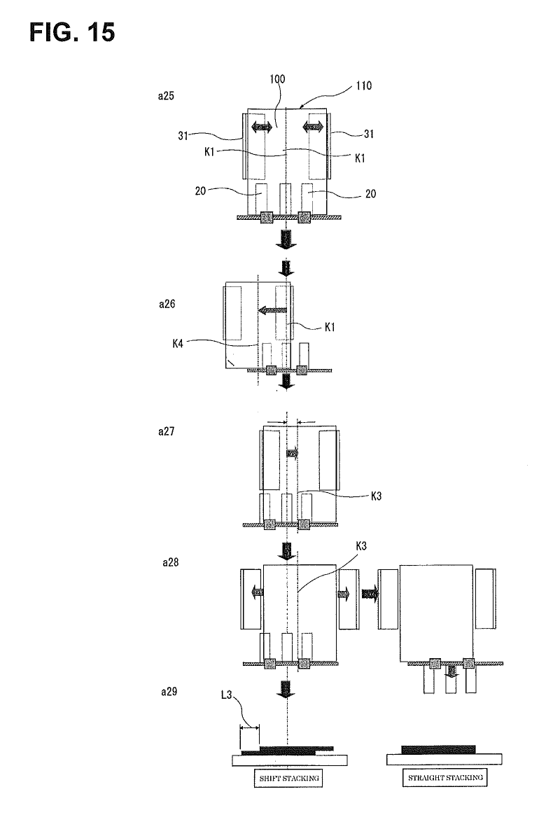

The operation in a case where stapling is performed will be explained with reference to FIGS. 14 and 15. The pair of right and left joggers 31 can be moved in the right and left directions with respect to the sheet discharge center position K1, the right-side end surface and the left-side end surface of the sheet 100 are aligned by the operation of the pair of right and left joggers 31 on the basis of the conveyed sheet discharge center position K1. The trailing end portion of the sheet 100 is supported by the supports 20 at the forward position (step a21).

After the right-side end surface and the left-side end surface of the sheet 100 are aligned, the sheets 100 are moved in the right direction while the right-side end surface and the left-side end surface of the sheet bundle 110 are sandwiched by the pair of right and left joggers 31, so that the sheets 100 are stapled at a staple position K4 by the staple device 40 (step a22). After stapling, the sheets 100 are moved returned in the left direction while the right-side end surface and the left-side end surface of the sheet bundle 110 are sandwiched by the pair of right and left joggers 31, so that the sheets 100 are at the stacking position K2 (step a23).

At this stacking position K2, the pair of right and left joggers 31 is opened, and the leading end side of the stapled sheet bundle 110 is dropped on the stacking tray 3, and only the trailing end portion of the sheet bundle 110 is placed on the supports 20. In this state, subsequently the supports 20 are moved backward, and the trailing end portion of the sheet bundle 110 placed on the supports 20 is dropped on the stacking tray 3 to be stacked (step a24).

Subsequently, the pair of right and left joggers 31 can be moved to the sheet discharge center position K1, and the right-side end surface and the left-side end surface of the sheet 100 subsequently fed are aligned by the operation of the pair of right and left joggers 31 on the basis of the sheet discharge center position K1. The trailing end portion of the sheet bundle 110 is supported by the supports 20 at the forward position (step a25).

After the right-side end surface and the left-side end surface of the sheet are aligned, the sheets 100 are moved in the right direction while the right-side end surface and the left-side end surface of the sheet bundle 110 are sandwiched by the pair of right and left joggers 31, so that the sheets 100 are stapled at a staple position K4 by the staple device 40 (step a26). After stapling, the sheets 100 are moved returned in the left direction while the right-side end surface and the left-side end surface of the sheet bundle 110 are sandwiched by the pair of right and left joggers 31, so that the sheets 100 are at the stacking position K3 (step a27).

At this stacking position K3, the pair of right and left joggers 31 is opened, and the leading end side of the stapled sheet bundle 110 is dropped on the stacking tray 3, and only the trailing end portion of the sheet bundle 110 is placed on the supports 20. In this state, subsequently the supports 20 are moved backward, and the trailing end portion of the sheet bundle 110 placed on the supports 20 is dropped on the stacking tray 3 to be stacked (step a28).

As described above, the following operations are repeated: an operation for aligning the sheet bundle 110 at the sheet discharge center position K1 and moving the sheet bundle 110 in one of the right and left directions, and performing stapling at the staple position K4 with the staple device 40; thereafter, an operation for moving and opening the pair of right and left joggers 31 at the stacking position K2 at one side, and moving the supports 20 backward and dropping the sheet bundle 110 on the stacking tray 3; an operation for aligning the sheet bundle 110 at the sheet discharge center position K1, moving the sheet bundle 110 in one of the right and left directions, and performing stapling at the staple position K4 with the staple device 40; and thereafter an operation for moving and opening the pair of right and left joggers 31 at the stacking position K3 at the other side, and moving the supports 20 backward and dropping and stacking the sheet bundle 110 on the stacking tray 3, so that the sheet bundles 110 are stacked with the deviation L3 alternately on the stacking tray 3 (step a29).

[Stacking Operation in a Case where Stapling is Performed]

Step a21 to step a24 explained in the shift stacking operation in a case where stapling is performed are repeatedly performed, but the operation at and after step a25 is not performed. As described above, the following operations are repeated: an operation for aligning the sheet bundle 110 at the sheet discharge center position K1, moving the sheet bundle 110 in one of the right and left directions, and performing stapling at the staple position K4 with the staple device 40; and thereafter an operation for moving and opening the pair of right and left joggers 31 at the stacking position K2 at one side, and moving the supports 20 backward and dropping and stacking the sheet bundle 110 on the stacking tray 3, so that the sheet bundles 110 can be stacked without any deviation alternately on the stacking tray 3.

### (Configuration of Discharge Means of Stapled Sheet Bundle)

The discharge means of a stapled sheet bundle includes sheet bundle discharge means 70 for discharging the stapled sheet bundle 110 and a stacking tray 3 for stacking the discharged stapled sheet bundle 110, and the discharge means of the stapled sheet bundle is configured as shown in FIGS. 6(a) to 6(c).

In the embodiment of FIG. 6(a), the sheet bundle discharge means 70 includes support driving means 201 and supports 20. The support driving means 201 drives the supports 20, and sets a discharge position of the stapled sheet bundle 110 from the supports 20 and a stacking position of the stapled sheet bundle 110 with the stacking tray 3, and configured to drop the stapled sheet bundle 110 on the stacking tray 3 and stack the stapled sheet bundle 110 in an overlapping manner without any positional deviation. The setting of the discharge position of the stapled sheet bundle 110 from the supports 20 and the stacking position of the stapled sheet bundle 110 with the stacking tray 3 is such a position that, when the supports 20 are moved backward, the stapled sheet bundle 110 drops on the stacking tray 3, but this position of dropping comes into contact with a reception wall 3a of the stacking tray 3, and the stapled sheet bundles 110 can be stacked so that the stapled sheet bundles 110 can be overlaid in such a manner that the positions of the stapled sheet bundles 110 on the stacking tray 3 are not displaced when the staples get stuck.

In the embodiment of FIG. 6(b), the sheet bundle discharge means 70 includes roller driving means 204 and a discharge roller 205. The roller driving means 204 drives the discharge roller 205, and sets a discharge position of a stapled sheet bundle discharged from the discharge roller 205 and a stacking position of the stapled sheet bundle 110 with the stacking tray 3, and configured to drop the stapled sheet bundle 110 on the stacking tray 3 and stack the stapled sheet bundle 110 in an overlapping manner without any positional deviation. The setting of the discharge position of the stapled sheet bundle 110 from the discharge roller 205 and the stacking position of the stapled sheet bundle 110 with the stacking tray 3 is such a position that the position where the stapled sheet bundle 110 drops on the stacking tray 3 is different in accordance with the conveying speed of the discharge roller 205, but this position of dropping comes into contact with a reception wall 3a of the stacking tray 3, and the stapled sheet bundles 110 can be stacked so that the stapled sheet bundles 110 can be overlaid in such a manner that the positions of the stapled sheet bundles 110 on the stacking tray 3 are not displaced when the staples get stuck.

In the embodiment of FIG. 6(c), the sheet bundle discharge means 70 includes clip driving means 206 and a discharge clip 207. The clip driving means 206 drives the discharge clip 207, and sets a discharge position of the stapled sheet bundle discharged from the discharge clip 207 and a stacking position of the stapled sheet bundle 110 with the stacking tray 3, and configured to drop the stapled sheet bundle 110 on the stacking tray 3 and stack the stapled sheet bundle 110 in an overlapping manner without any positional deviation. The setting of the discharge position of the stapled sheet bundle 110 from the discharge clip 207 and the stacking position of the stapled sheet bundle 110 with the stacking tray 3 is such a position that the position where the stapled sheet bundle 110 drops on the stacking tray 3 is different in accordance with the conveying speed of the discharge clip 207, but this position of dropping comes into contact with a reception wall 3a of the stacking tray 3, and the stapled sheet bundles 110 can be stacked so that the stapled sheet bundles 110 can be overlaid in such a manner that the positions of the stapled sheet bundles 110 on the stacking tray 3 are not displaced when the staples get stuck.

As described above, the discharge position of the stapled sheet bundle 110 from the sheet bundle discharge means 70 and the stacking position of the stapled sheet bundle 110 with the stacking tray 3 are set, so that the stapled sheet bundles 110 is stacked so that the stapled sheet bundles 110 are overlaid in such a manner that the positions of the stapled sheet bundles 110 on the stacking tray 3 are not displaced, and therefore, the stapled sheet bundles 110 can be stacked so that the stapled sheet bundles 110 can be overlaid in such a manner that the positions of the stapled sheet bundles 110 on the stacking tray 3 are not displaced when the staples get stuck.

### (Configuration of Staple Device)

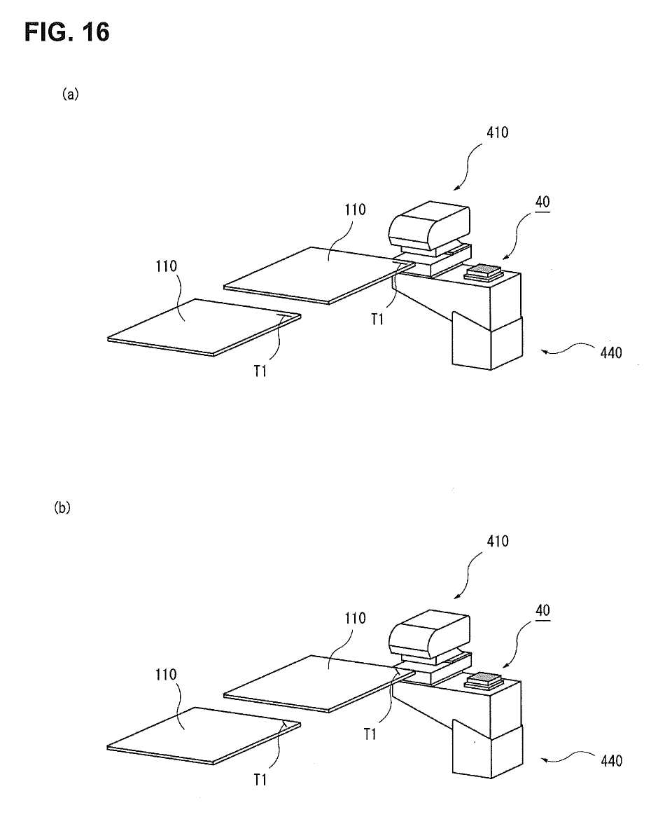

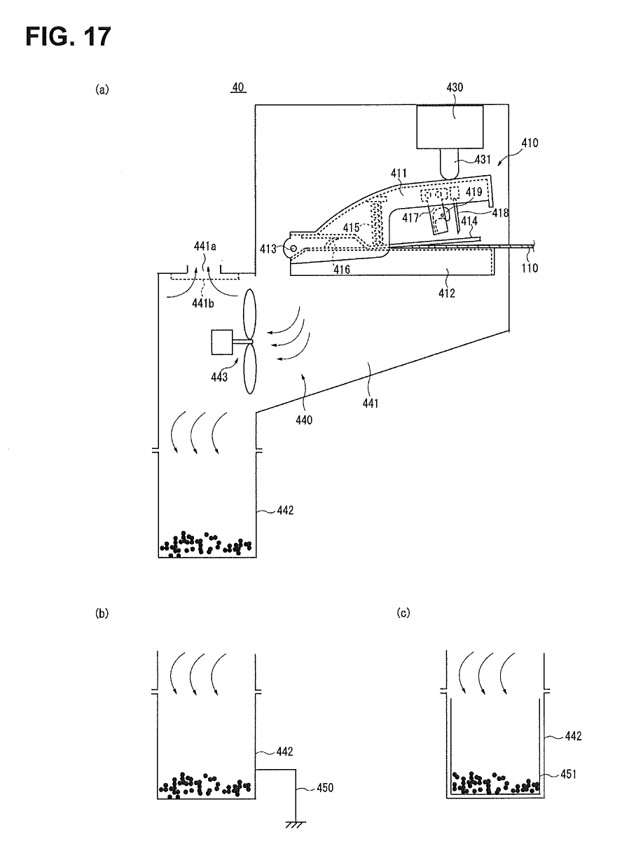

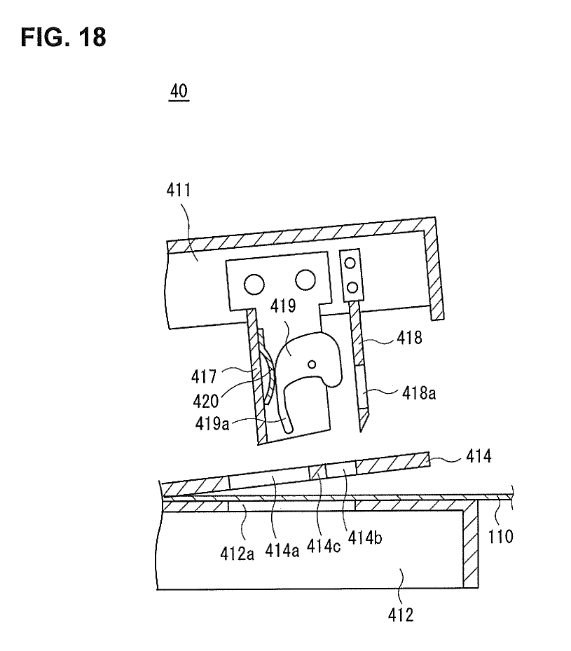

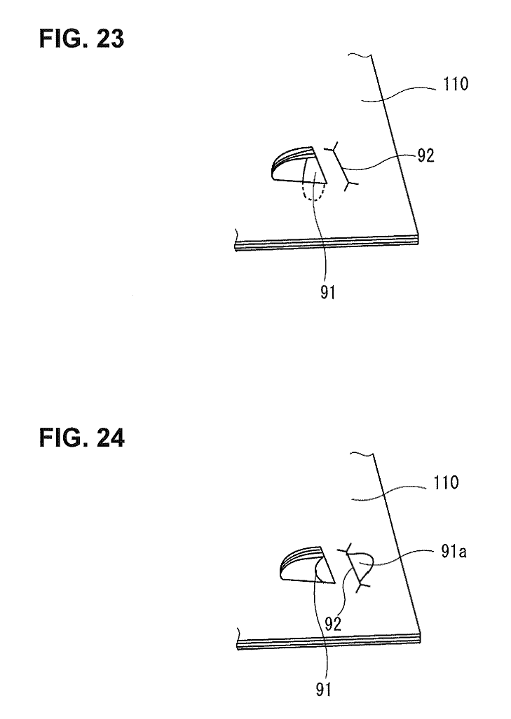

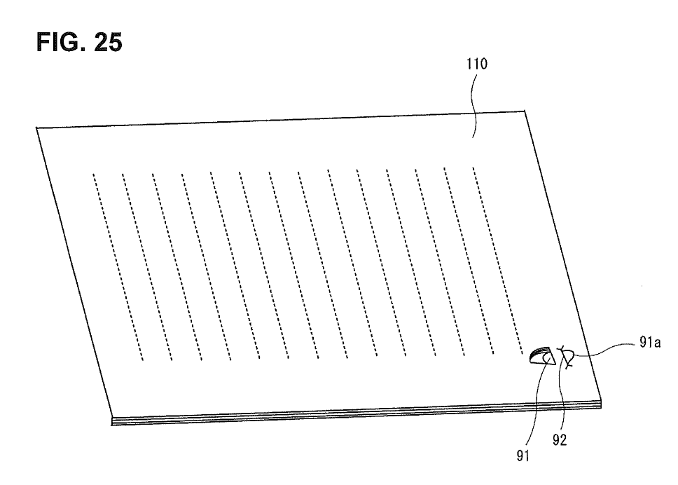

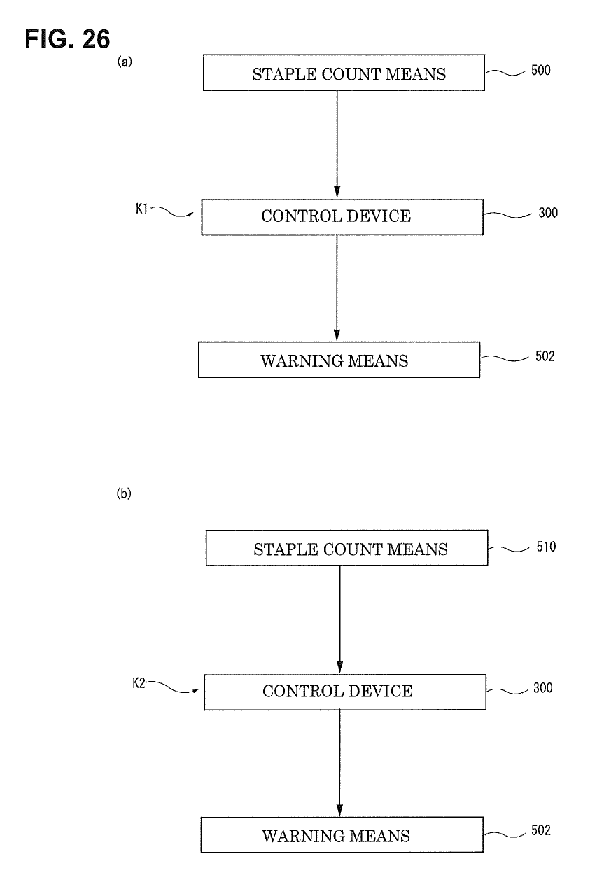

The sheet post-processing device according to this embodiment is connected to the image forming apparatus, and the image forming apparatus successively feeds sheets on which images are formed on the basis of the input image data, and the sheet post-processing device according to this embodiment applies predetermined post-processing to the fed sheets, and includes a staple device as shown in FIGS. 16(a) and 16(b) to FIGS. 26(a) and 26(b). FIGS. 16(a) and 16(b) are perspective views illustrating an external appearance of a staple device. FIGS. 17(a) to 17(c) are cross sectional views of a staple device. FIGS. 18 to 22 are figures illustrating operation for closing a sheet bundle. FIG. 23 is a perspective view illustrating a sheet bundle before stapling is performed. FIG. 24 is a perspective view illustrating a sheet bundle when stapling is performed. FIG. 25 is a figure illustrating a stapled sheet bundle. FIGS. 26(a) and 26(b) are configuration diagrams illustrating warning means.

The staple device 40 according to this embodiment includes a staple unit 410 and a paper particle dust accommodation unit 440. The staple unit 410 is not limited to this embodiment as long as the staple unit 410 binds image-formed sheets without using any staple, and may use a well-known unit.

In the actual embodiment of FIG. 16(a), the position T1 where the staple unit 410 staples the sheet bundle 110 is at the rear end corner portion of the sheet bundle 110 and is parallel with the rear end. In the actual embodiment of FIG. 16(b), the position T1 where the staple unit 410 staples the sheet bundle 110 is at the rear end corner portion of the sheet bundle 110 and is at an angle of 45 degrees from the rear end. The position T1 where the staple unit 410 staples the sheet bundle 110 is not limited to the actual embodiment of FIG. 16(a) and the actual embodiment of FIG. 16(b), and can be arranged at various positions according to the structure of the staple unit 410.

The staple unit 410 according to this embodiment is such that an upper form 411 is pivotably supported by a support shaft 413 with respect to a lower form 412. A pressing plate 414 is arranged between the upper form 411 and the lower form 412, and is supported pivotably by the support shaft 413. A compression coil spring 415 is arranged between the upper form 411 and the pressing plate 414, and a leaf spring 416 is arranged between the pressing plate 414 and the upper form 411.

The staple unit 410 is provided with a driving device 430 for pivoting the upper form 411. This driving device 430 is constituted by, for example, an electromagnetic solenoid, and when the power is turned on, a plunger 431 presses the upper form 411 to rotate the upper form 411 against the compression coil spring 415, and when the power is turned off, the upper form 411 returns back to the original position by the compression coil spring 415.

A cutting blade 417, a knife 418, and a cam 419 are attached to the upper form 411. A cam 419 is arranged between the cutting blade 417 and the knife 418. The cam 419 is pivotably supported by the cutting blade 417 fixed to the upper form 411. The leaf spring 420 engages with the back surface of the cam 419. The blade surface of the cutting blade 417 is formed in a U shape, and the cross section of the knife 418 is formed in a 1 shape, and these are combined, so that, as shown in FIG. 23, a U-shaped cut-in tongue portion 91 and an I-shaped cut-in hole 92 are formed. A substantially rectangular window 418a is opened at a central portion of the knife 418. Substantially rectangular holes 414a, 414b are formed in the pressing plate 414, and a substantially rectangular hole 412a is formed in the lower form 412 to be arranged opposite to the cutting blade 417 and the knife 418.

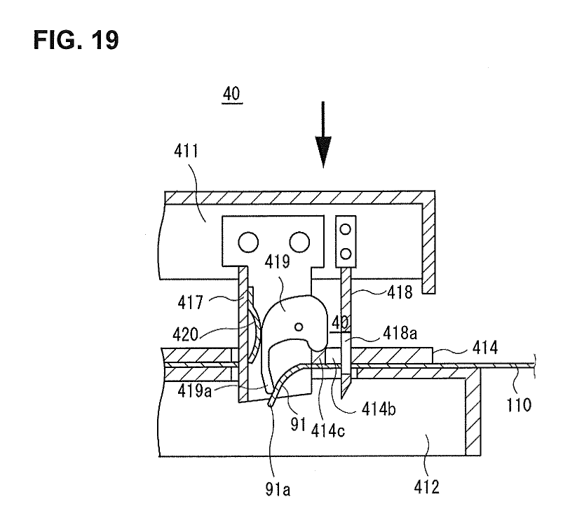

Subsequently, operation of the staple unit 410 will be explained with reference to FIGS. 18 to 25. First, the sheet bundle 110 is placed between the lower form 412 and the pressing plate 414 (FIG. 18). Subsequently, the driving device 430 is turned on, and the plunger 431 presses the upper form 411 to a predetermined position, the cutting blade 417 and the knife 418 penetrate through the holes 414a, 414b, respectively of the pressing plate 414, and penetrate through the sheet bundle 110 and enter the hole 412a provided in the lower form 412. At this occasion, a U-shaped cut-in tongue portion 91 is formed in the sheet bundle 110 by the cutting blade 417, and an I-shaped cut-in hole 92 is formed in the sheet bundle 110 by the cutting blade 418, a claw 419a of the cam 419 engages with the U-shaped cut-in tongue portion 91 thus cut, and pushes up the U-shaped cut-in tongue portion 91 (FIG. 19).

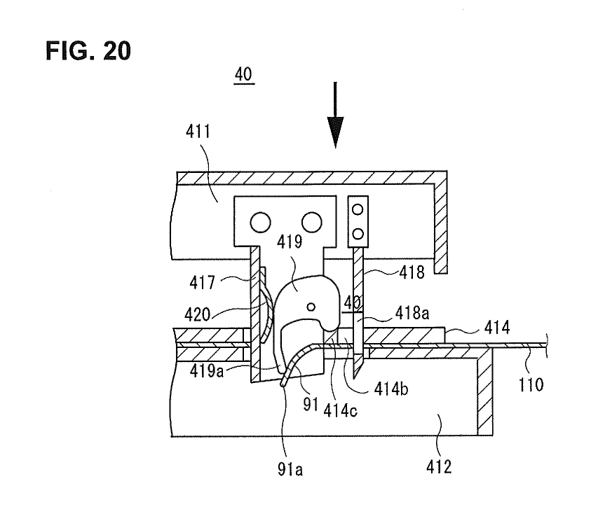

Then, when the upper form 411 is further pushed down, the cam 419 rotates in the counterclockwise direction about an intermediate portion 414c between the holes 414a, 414b of the pressing plate 414. At this occasion, the claw 419a of the cam 419 presses and bends the U-shaped cut-in tongue portion 91, and the leading end is passed into the window 418a of the knife 418 (FIG. 20).

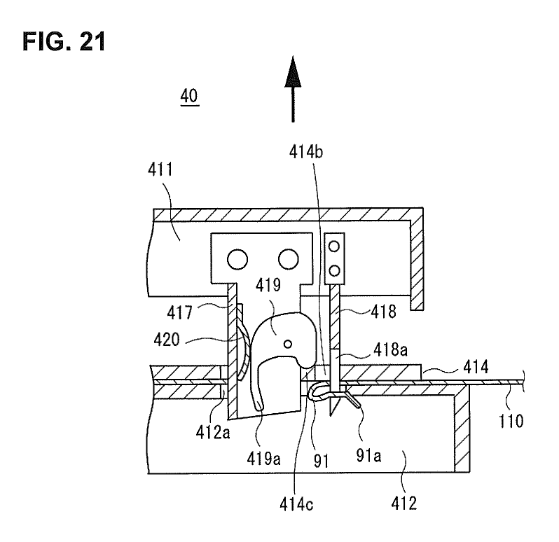

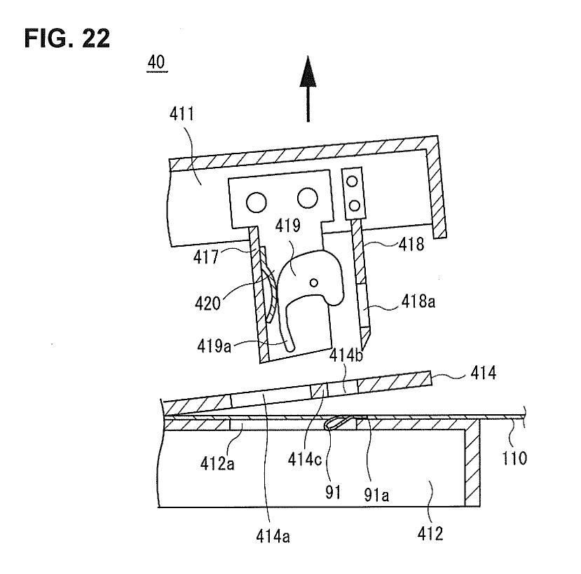

When the driving device 430 is turned off, the upper form 411 returns back to the original position due to the effect of the compression spring 415. Therefore, due to the effect of the leaf spring 420, the cam 419 is rotated in the clockwise direction and brought back to the original position (FIG. 21). At this occasion, both of the cutting blade 417 and the knife 418 are rising, and the cutting blade 417 comes out of the sheet bundle 110 as it is, but the knife 418 causes the leading end of the U-shaped cut-in tongue portion 91 of the sheet bundle 110 to be held by the window 418a, and the leading end of the U-shaped cut-in tongue portion 91 is inserted into the I-shaped cut-in hole 92 opened by the knife 418, and then the knife 418 comes out of the sheet bundle 110 (FIG. 22).

As a result, the staple operation of the sheet bundle 110 is completed, and as shown in FIGS. 24 and 25, the leading end of the U-shaped cut-in tongue portion 91 is inserted into the I-shaped cut-in hole 92, and the side where the leading end is exposed is the front side of the sheet bundle 110, and more specifically, the side where the leading end is exposed is the side where the image is formed.

The paper particle dust accommodation unit 440 is arranged at the lower side position of the staple unit 410, and the paper particle dust accommodation unit 440 accommodates paper particle dust generated when the U-shaped cut-in tongue portion 91 and the I-shaped cut-in hole 92 are formed by cutting with the staple unit 410. This paper particle dust accommodation unit 440 includes a dust shoot 441 guiding paper particle dust, a storage box 442 accumulating paper particle dust, and a fan 443 constituting dust collector means collecting the paper particle dust into the storage box 442. In this embodiment, the dust collector means is constituted by the fan 443, but a pressure reduction device may be used instead. This dust collector means is driven while the staple device performs the staple operation.

The dust shoot 441 is in communication from the staple unit 410 to the storage box 442, and the fan 443 is arranged in this dust shoot 441, and an exhaust port 441a is formed at the upper side position of the dust shoot 441. The exhaust port 441a is provided with a filter 441b for preventing the paper particle dust from leaking. By driving the fan 443, the paper particle dust can be guided via the dust shoot 441, and the paper particle dust can be reliably accumulated in the storage box 442. The storage box 442 is detachable, and the storage box 442 is detached at a predetermined period to be replaced, or the paper particle dust is discharged.

The sheet post-processing device according to this embodiment includes warning means K1 for detecting the number of times the staple operation is performed, and notify removal of the paper particle dust accumulated in the paper particle dust accommodation unit when the number of times the staple operation is performed attains the number of operations that has been set as shown in FIG. 26(a). This warning means K1 includes staple operation count means 500 for counting staple operations in the staple unit 410, and sends the count information to the control device 300. The control device 300 drives warning means 502 when the staple operation count means 500 makes a predetermined count, and notifies the user of the discharge period of the paper particle dust accumulated in the storage box 442. Accordingly, the user can reliably replace the storage box 442, or discharge the paper particle dust accumulated in the storage box 442. The warning means 502 is constituted by a warning lamp or a warning buzzer.

As shown in FIG. 26(b), warning means K2 may be provided to detect the number of sheets to be stapled and notify removal of the paper particle dust accumulated in the paper particle dust accommodation unit 440 when the number of sheets having been stapled attains the number of stapled sheets that has been set. When the image forming apparatus receives a number of sheets to be stapled, this warning means K2 includes a sheet count means 510 for detecting the number of sheets to be stapled on the basis of this number of sheets that has been received and the number of times the stapling is performed, and sends the count information to the control device 300. When the sheet count means 510 counts the number of stapled sheets that has been set, the control device 300 drives the warning means 502 to notify the discharge period of the paper particle dust accumulated in the storage box 442.

As described above, the U-shaped cut-in tongue portion 91 and the I-shaped cut-in hole 92 are automatically formed in the sheet bundle 110 made up with multiple sheets, and each sheet of the sheet bundle 110 is joined with each other with the U-shaped cut-in tongue portion 91 and the I-shaped cut-in hole 92, so that the sheet bundle 110 is stapled, but the paper particle dust generated when the U-shaped cut-in tongue portion 91 and the I-shaped cut-in hole 92 are formed by cutting in are accommodated, and therefore, there is no need to provide a sensor for checking the state of filling of the staples, and this makes the structure simpler, and the paper particle dust generated in the staple-processing would not smear images on sheets or would not spread inside of the device.

In the embodiment of FIG. 17(a), the storage box 442 is detachable, and configured to be able to be detached and replaced with a predetermined period, and discharge the paper particle dust. However, the paper particle dust may stick to the storage box 442 due to static electricity. In the embodiment of FIGS. 17(b) and 17(b), the storage box 442 is provided with preventing means for preventing the paper particle dust from attaching to the inner wall of the storage box 442, and the paper particle dust does not attach to the inner wall of the storage box 442, so that the paper particle dust can be easily retrieved from the storage box 442. In the embodiment of FIG. 17(b), the storage box 442 is earthed 450 to be configured such that the paper particle dust does not attach to the storage box 442 due to the electricity. In the embodiment of FIG. 17(c), an adhesive tape container 451 is detachably attached to the inside of the storage box 442, and the paper particle dust adheres to the adhesive tape container 451, and the adhesive tape container 451 is configured to be detached and discarded.

### INDUSTRIAL APPLICABILITY

This invention is applied to a sheet post-processing device conventionally connected to an image forming apparatus such as a copier and a printer, and performing staple-processing for biding image-formed sheets without using any staple, and the paper particle dust generated in the staple-processing for biding image-formed sheets without using any staple would not smear images on sheets or would not spread inside of the device.

### REFERENCE SIGNS LIST

1 sheet post-processing device
2 device main body
3 stacking tray
3a reception wall
10 sheet conveying means
11 conveying guide
12 conveying roller
20 support
30 jogger and stack means
31 pair of right and left joggers
31a lower guide
31b upper guide
31c connection guide
32 slide lever
33 protrusion
34 arm
35 auxiliary lever
36 link
37 safety switch
38 moving body
40 staple device
50 sheet bundle holder
91 U-shaped cut-in tongue portion
92 I-shaped cut-in hole
100 sheet
110 sheet bundle
200 conveying driving means
201 support driving means
202 jogger driving means
203 jogger moving driving means
300 control device
410 staple unit
411 upper form
412 lower form
413 support shaft
414 pressing plate
415 compression coil spring
416 leaf spring
417 cutting blade
418 knife
419 cam
420 leaf spring
430 driving device 431 plunger
440 paper particle dust accommodation unit
441 dust shoot
442 storage box
443 fan
500 staple operation count means
510 sheet count means
502 warning means
K1, K2 warning means

1. A sheet post-processing device connected to an image forming apparatus, the sheet post-processing device being successively fed with sheets on which images are formed by the image forming apparatus on the basis of input image data, the sheet post-processing device applying predetermined post-processing onto the fed sheet,
the sheet post-processing device comprising:
a staple unit configured to automatically form a cut-in tongue portion and a cut-in hole in a predetermined shape through a sheet bundle including a plurality of sheets, insert the cut-in tongue portion into the cut-in hole to join the sheets of the sheet bundle with each other, and staple the sheet bundle;
sheet bundle discharge means configured to discharge the stapled sheet bundle; and
a stacking tray configured to stack the stapled sheet bundle discharged,
wherein a discharge position of the stapled sheet bundle discharged by the sheet bundle discharge means and a stacking position of the stapled sheet bundle with the stacking tray are set so that the stapled sheet bundle is dropped and stacked so that the stapled sheet bundle is overlaid in such a manner that the position of the stapled sheet bundle on the stacking tray is not displaced.

2. The sheet post-processing device according to claim 1, wherein the sheet bundle discharge means includes:
a support, wherein when the support is at a forward position, the support drops a leading end side of the stapled sheet bundle onto the stacking tray, so that only a trailing end portion of the sheet bundle is placed on the support, and when the support is moved backward, the support drops the trailing end portion of the sheet bundle onto the stacking tray to stack the sheet bundle; and
support driving means configured to move the support forward and backward,
wherein the support driving means drives the support, and sets the discharge position of the stapled sheet bundle from the support and the stacking position of the stapled sheet bundle with the stacking tray, and is configured to drop the stapled sheet bundle on the stacking tray and stack the stapled sheet bundle in an overlapping manner without any positional deviation, and
the setting of the discharge position of the stapled sheet bundle from the support and the stacking position of the stapled sheet bundle with the stacking tray is such that, when the support is moved backward, a position where the stapled sheet bundle drops on the stacking tray is a position of coming into contact with a reception wall of the stacking tray, and the stapled sheet bundle is stacked so that the stapled sheet bundle is overlaid in such a manner that the position of the stapled sheet bundle is not displaced.

3. The sheet post-processing device according to claim 1, wherein the sheet bundle discharge means includes:
a discharge roller configured to discharge the stapled sheet bundle onto the stacking tray; and
roller driving means configured to drive the discharge roller,
wherein the roller driving means drives the discharge roller, and sets the discharge position of the stapled sheet bundle from the discharge roller and the stacking position of the stapled sheet bundle with the stacking tray, and is configured to drop the stapled sheet bundle on the stacking tray and stack the stapled sheet bundle in an overlapping manner without any positional deviation, and
the setting of the discharge position of the stapled sheet bundle from the discharge roller and the stacking position of the stapled sheet bundle with the stacking tray is such that a position where the stapled sheet bundle drops is a position of coming into contact with a reception wall of the stacking tray, and the stapled sheet bundle is stacked so that the stapled sheet bundle is overlaid in such a manner that the position of the stapled sheet bundle is not displaced.

4. The sheet post-processing device according to claim 1, wherein the sheet bundle discharge means includes:
a discharge clip configured to discharge the stapled sheet bundle onto the stacking tray; and
clip driving means configured to drive the discharge clip,
wherein the clip driving means drives the discharge clip, and sets the discharge position of the stapled sheet bundle from the discharge clip and the stacking position of the stapled sheet bundle with the stacking tray, and is configured to drop the stapled sheet bundle on the stacking tray and stack the stapled sheet bundle in an overlapping manner without any positional deviation, and
the setting of the discharge position of the stapled sheet bundle from the discharge clip and the stacking position of the stapled sheet bundle with the stacking tray is such that a position where the stapled sheet bundle drops is a position of coming into contact with a reception wall of the stacking tray, and the stapled sheet bundle is stacked so that the stapled sheet bundle is overlaid in such a manner that the position of the stapled sheet bundle is not displaced.

5. The sheet post-processing device according to claim 1 further comprising a paper particle dust accommodation unit configured to accommodate paper particle dust generated when the cut-in tongue portion and the cut-in hole in the predetermined shape are formed.

6. The sheet post-processing device according to claim 5 further comprising warning means configured to notify removal of the paper particle dust accumulated in the paper particle dust accommodation unit.

7. The sheet post-processing device according to claim 6, wherein the warning means is configured to detect the number of times the staple operation is performed, and notify removal of the paper particle dust accumulated in the paper particle dust accommodation unit when the number of times the staple operation is performed attains the number of operations that has been set.

8. The sheet post-processing device according to claim 6, wherein the warning means detects the number of sheets to be stapled, and notify removal of the paper particle dust accumulated in the paper particle dust accommodation unit when the number of sheets to be stapled attains the number of sheets that has been set.

9. The sheet post-processing device according to claim 5, wherein the paper particle dust accommodation unit includes:
a dust shoot configured to guide the paper particle dust;
a storage box configured to accumulate the paper particle dust; and
dust collector means configured to collect the paper particle dust into the storage box.

10. The sheet post-processing device according to claim 9, wherein the storage box is provided with preventing means configured to prevent the paper particle dust from attaching to an inner wall of the storage box.

11. The sheet post-processing device according to claim 9, wherein the storage box is detachable.
